(19) United States
(12) Patent Application Publication
(10) Pub. No.: US 2025/0099806 A1
(43) Pub. Date: Mar. 27, 2025

(54) SACROILIAC JOINT EXERCISE DEVICE

(71) Applicant: SIJ Therapeutics, LLC, Orlando, FL (US)

(72) Inventors: Tejash Dungarani, Orlando, FL (US); Raymond Catania, Palm Bay, FL (US); Kenan Dunton, Cocoa, FL (US); Christine Bralich, Satellite Beach, FL (US)

(73) Assignee: SIJ Therapeutics, LLC, Orlando, FL (US)

(21) Appl. No.: 18/897,607

(22) Filed: Sep. 26, 2024

Related U.S. Application Data
(60) Provisional application No. 63/585,304, filed on Sep. 26, 2023.

(51) Int. Cl. A63B 21/00; A63B 21/02; A63B 23/04

(52) U.S. Cl. CPC A63B 21/4049; A63B 21/022; A63B 23/0482

(57) ABSTRACT

An exercise device including a base, a vertical extension member, a vertical sliding member, an arm rotation member, an arm member, a resistance apparatus configured to attach to the arm rotation member and to the arm member at a first end of the arm member and provide resisted rotation of the arm member about a second axis, and an interfacing member attached toward a second end of the arm member and configured to interface with the body of a user and enable the user to rotate the arm member about the second axis.

### RELATED APPLICATIONS

This application claims priority under 35 U.S.C. § 119(e) of U.S. Provisional Patent Application Ser. No. 63/585,304 (Attorney Docket No. 7843.00002) filed on Sep. 26, 2023 and titled Sacroiliac Joint Exercise Device. The content of this application is incorporated herein by reference.

### FIELD OF THE INVENTION

The present invention relates to a device to facilitate exercising the sacroiliac joint.

### BACKGROUND OF THE INVENTION

Exercising the sacroiliac joint (SIJ) is an important part of many flexibility and rehabilitation regimens. Having correct form and flexure in performing SIJ exercises is important to the effectiveness of those exercises. Accordingly, the correct placement of exercise devices configured to facilitate SIJ exercises relative to the body of the person performing the exercises is crucial (i.e. patient). Moreover, guiding the patient through the exercise by maintaining constant contact with the patient, and providing a sufficient level of resistance on the patient, ensures the effectiveness of the exercise.

Prior devices for performing SIJ exercises have lacked in at least one of being sufficiently customizable in terms of height, length, and/or angular position about at least two axes to ensure effectiveness of the exercise device. Additionally, prior devices have typically not been configured to provide consistent resistance to the SIJ exercise for improved exercise effectiveness. Accordingly, there is a need in the art for an SIJ exercise device having vertical, horizontal, and rotational customization about at least two axes and operable to provide consistent resistance during SIJ exercise.

### SUMMARY OF THE INVENTION

With the above in mind, embodiments of the present invention are related to an exercise device comprising a base, a vertical extension member configured to extend upward from the base, a vertical sliding member configured to slide along a portion of a length of the vertical extension member, an arm rotation member configured to attach to the vertical sliding member, rotate about a first axis, and be selectively retained in an angular location about the first axis, and an arm member. The exercise device may further comprise a resistance apparatus configured to attach to the arm rotation member and to the arm member at a first end of the arm member and provide resisted rotation of the arm member about a second axis. The exercise device may further comprise an interfacing member attached toward a second end of the arm member and configured to interface with the body of a user and enable the user to rotate the arm member about the second axis.

In some embodiments, the arm member may be a telescoping arm member operable to extend along a longitudinal axis thereof. The arm member may further comprise a tube coupling member operable to secure the arm member at a desired length.

In some embodiments, the vertical sliding member may comprise a mounting platform, the mounting platform comprising a plurality of recesses. The arm rotation member may be attached to the mounting platform and comprises an angle selection structure configured to be positionable within the recesses of the plurality of recesses to selectively retain the arm rotation member in an angular rotation about the first axis. In further embodiments, the recess of the plurality of recesses may be positioned at angular intervals and along an arc. In other embodiments, the angle selection structure may comprises an aperture configured to align with the recesses of the plurality of recesses and an angle selection structure retaining member configured to pass through the aperture and into the recesses of the plurality of recesses.

In some embodiments, the vertical extension member may comprise one or more track channels extending vertically along the vertical extension member and a plurality of apertures. The vertical sliding member may comprise one or more attaching members configured to slidably attach the vertical sliding member to the vertical extension members such that the vertical sliding member may translate along the one or more track channels and a position retaining member configured to be selectively positionable within the plurality of apertures to selectively retain the vertical sliding member at a vertical position along the vertical extension member.

In some embodiments, the resistance apparatus may comprise a housing and at least one resistance member positioned at least partially within the housing and configured to resist rotation about the second axis in at least one direction. Rotation of the arm member about the second axis may cause the housing to rotate about the second axis. The at least one resistance member may comprises at least one spring. A first end of the at least one spring may be positioned to interface with a structure of the arm rotation member and a second end of the at least one spring may be positioned to interface with the housing and be rotated as the housing rotates about the second axis. Rotation of the second end of the at least one spring may be prevented by the interface with a structure of the arm rotation member, causing resistance to the rotation of the first end of the at least one spring, and thereby resisting rotation of the arm member about the second axis. In some further embodiments, the at least one resistance member may comprise two springs, the first end of the two springs extends downward from the housing and interfaces with a recess comprised by an arm of an angle selection structure of the arm rotation member, and the second end of the two springs interfaces with a spring housing comprised by the housing.

In some embodiments, the interfacing member may comprise an attachment section configured to attach to the arm member, a body section, and one or more interfacing devices carried by the body section and configured to interface with the body of the user. The one or more interfacing devices may comprise at least one rotating member configured to rotate while interfaced with the body of the user.

In some embodiments, the vertical extension member further may comprise an attachment structure configured to rotatably attach the vertical extension member to the base such that the vertical extension member is rotatable about a third axis relative to the base. In some embodiments, the first axis is perpendicular to the second axis.

### BRIEF DESCRIPTION OF THE DRAWINGS

FIG. 1 is a perspective view of a sacroiliac joint (SIJ) exercise device according to an embodiment of the invention.

FIG. 2 is a lower plan view of the SIJ exercise device of FIG. 1.

FIG. 3 is a side perspective view of the SIJ exercise device of FIG. 1.

FIG. 4 is a rear elevation view of the SIJ device of FIG. 1.

FIG. 5 is a partial perspective view of a mounting platform of the SIJ device of FIG. 1.

FIG. 6 is a partial upper perspective view of the SIJ device of FIG. 1.

FIG. 7 is a view of the SIJ exercise device of FIG. 1 in a collapsed configuration.

FIG. 8 is a partial lower perspective view of the SIJ device of FIG. 1.

FIG. 9 is a plan view of an angle selection structure of the SIJ device of FIG. 1.

FIG. 10 is a partial perspective view of a resistance apparatus of the SIJ device of FIG. 1, with a side panel of a housing of the resistance apparatus being removed.

FIG. 11 is a partial front perspective view of the of the SIJ device of FIG. 1 showing the resistance apparatus.

FIG. 12 is a perspective view of an interfacing member of the SIJ device of FIG. 1.

FIG. 13 is a perspective view of an SIJ exercise device according to an embodiment of the invention.

FIG. 14 is a perspective view of an interfacing member of the SIJ device of FIG. 13.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

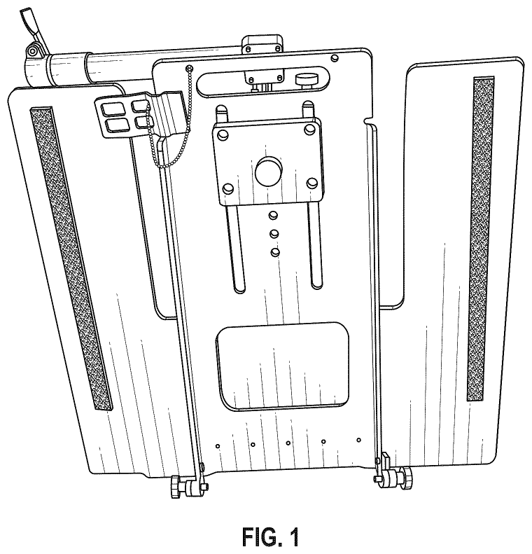

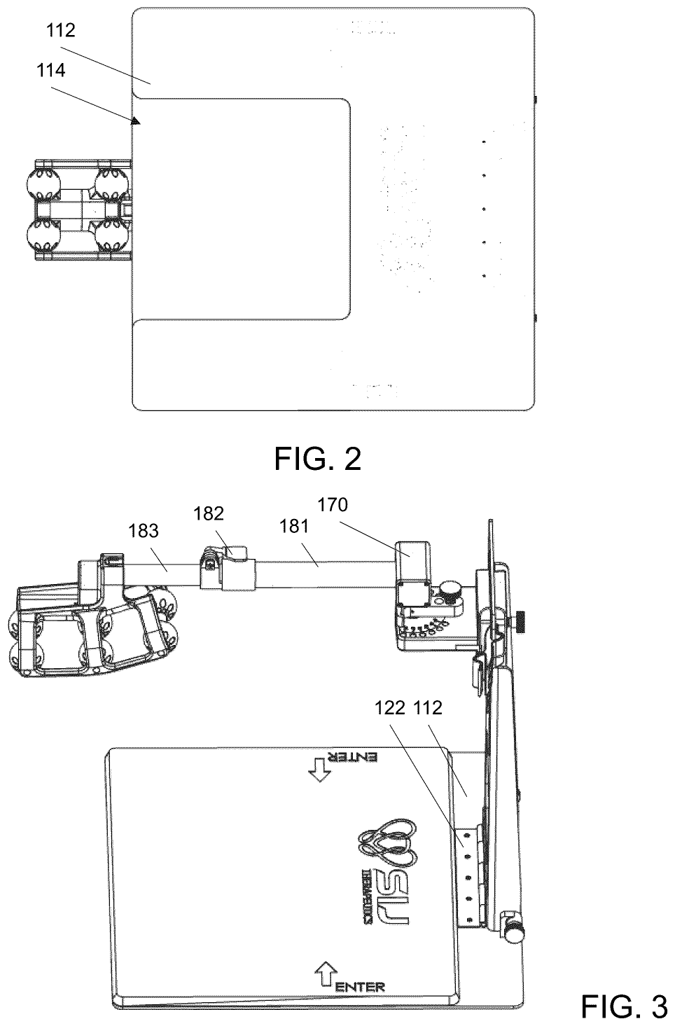

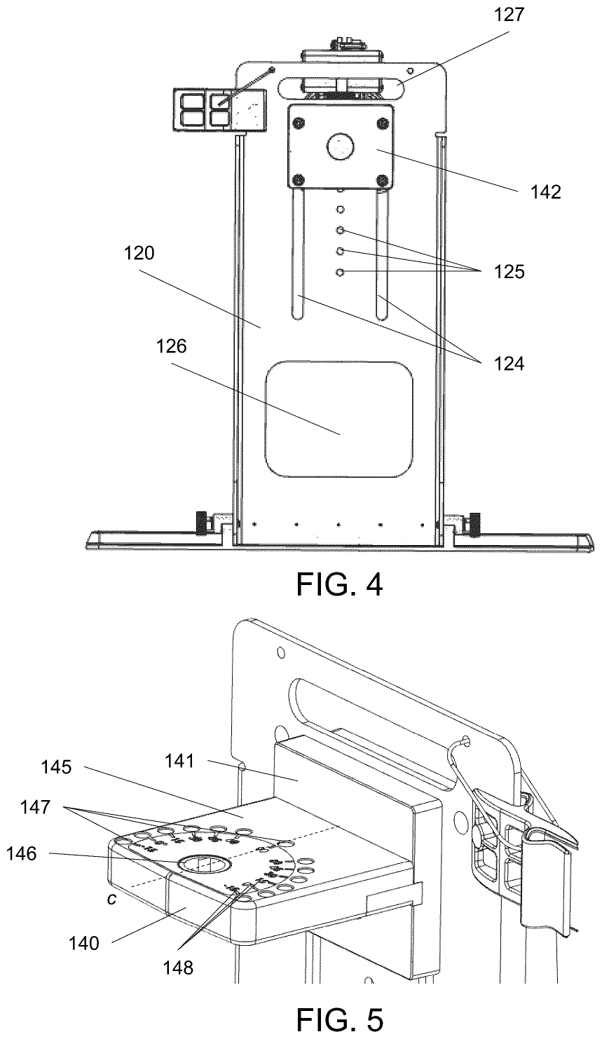

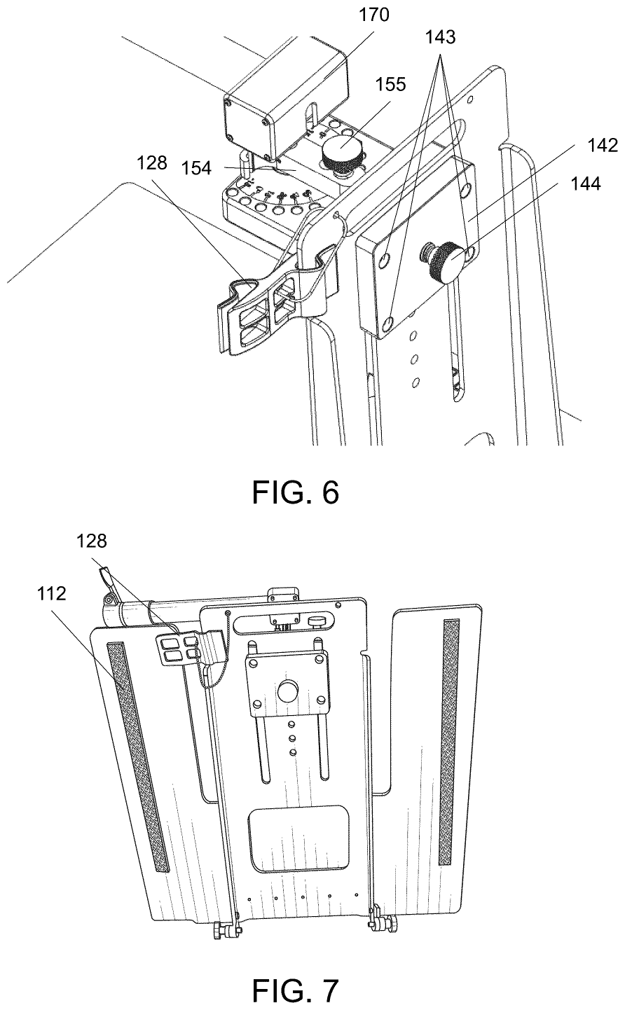

An embodiment of the invention, as shown and described by the various figures and accompanying text, provides a device to facilitate the exercise of the sacroiliac joint. Referring now to FIGS. 1-12, an exercise device 100 according to an embodiment of the invention is presented. The device 100 may comprise a base 110, a vertical extension member 120, a vertical sliding member 140, an arm rotation member 150, an arm 180, and an interfacing apparatus 190. The base 110 may be configured to rest on a surface in the environment, for example, on the floor of a room or any other surface where a patient can lie down, extending beyond lateral ends 102, 104 of the device 100. The vertical extension member 120 may be attached to the base 110 and configured to extend upward from the base 110. The vertical sliding member 140 may be coupled to the vertical extension member 120 and be configured to slide along a length of the vertical extension member 120 and temporarily secured at a position along the length of the vertical extension member 120. The arm rotation member 150 may be attached to and carried by the vertical sliding member 140 and may further be attached to the arm 180. The arm rotation member 150 may be configured to rotate in a first direction about an arm rotation axis a, thereby rotating arm 180 about axis a, and about a second axis r. Arm 180 may be attached to the arm rotation member 150 at a proximal end thereof and extend outward from the arm rotation member 150 in a direction generally away from the vertical extension member 120 such that the arm 180 is generally above the base 110. The interfacing member 190 may be attached towards a distal end of the arm 180 and configured to interface with a body part of the user.

The base 110 may comprise a lower interfacing member 112 and a support member 116. The lower interfacing member 112 may be configured such that a lower surface thereof interfaces with a surface in the environment as described above. The lower surface of the lower interfacing member 112, or portions thereof, may be configured to prevent slipping/sliding of the device 100 with respect to the surface of the environment. In some embodiments, the lower interfacing member 112 or portions thereof may be formed of, or have applied to a lower surface thereof, an anti-slip material having a relatively high static coefficient of friction. The lower interfacing member 112 may further comprise a cutout section 114. The cutout section 114 may be configured to reduce the material usage of the lower interfacing member 112 while still maintaining sufficient structural strength and integrity for the device 100 and to prevent the device 100 from tipping over. The support member 116 may be fixedly attached to an upper surface of the lower interfacing member 112. Such attachment may be accomplished by any means or method as is known in the art, including, but not limited to, adhesives, glues, bonding, fasteners, magnetic attachment, and the like. In other embodiments, the support member 116 may be detached from the lower interfacing member 112 and removable therefrom. The support member 116 may comprise or be formed of a material configured to provide support to the body of a user that lays down thereupon. The support member 116 may be generally coextensive with at least a portion of the lower interfacing member 112. Additionally, the support member 116 may extend across the cutout section 114.

As noted above, the vertical extension member 120 may be attached to the base 110. More specifically, the vertical extension member may comprise an attachment structure 121, wherein the attachment structure 121 is configured to attach the vertical extension member 120 by attaching to a section of the base 110. In the present embodiment, the attachment structure 121 is attached to a proximal portion of the lower interfacing member 112. Such attachment may be accomplished by any means or method as is known in the art, including, but not limited to, fasteners, welding, interference fits, adhesives, magnetic attachment, and the like. In the present embodiment, the attachment structure 121 is configured as a hinge. In such a configuration, the attachment structure 121 may attach on a first side to the lower interfacing member 112 and on a second side to a lower end of a body member 122 of the vertical extension member 120. The hinge may permit the body member 122 to rotate about axis b, thereby facilitating the collapsing of the device 100 for storage.

Additionally, the base 110 may further comprise a pair of retaining support structures 118 and retaining devices 119. The retaining support structures 118 may extend upward from the lower interfacing member 112 at locations that permit the body member 122 to be positioned therebetween. The retaining devices 119 may be manipulable by the user and extend through apertures of each of one of the retaining support structure 118 and a sidewall 123 of the body member 122 to releasably secure the body member 122 in a vertical orientation. The user may pull the retaining devices 119 away from the body member 122 to remove the retaining devices 119 from the apertures of the sidewall 123 to permit the body member 122 to rotate about axis b.

The vertical extension member 120, when positioned as shown in FIG. 1, may extend generally vertically/upward from the base 110. As mentioned above, the vertical extension member 120 may comprise a body member 122 which comprises opposing sidewalls 123 that extend vertically along the length of the body member 122. The body member 122 may be configured to facilitate the attachment of the vertical sliding member 140 thereto. Moreover, the body member 122 may be configured the vertical sliding member 140 to be temporarily secured at a vertical location along the length of the body member 122 and then be subsequently unsecured, translated vertically, either up or down, and then resecured at a new vertical location. Any configurations that may accomplish such attachment and temporary securing along the length of the body member 122 are contemplated and included within the scope of the invention. In the present invention, the body member 122 comprises a pair of track channels 124 and a plurality of apertures 125. The plurality of apertures 125 may be arranged in a line along a centerline of the long axis of the body member 122 and may be spaced at equal intervals. The track channels 124 may be positioned on either side of the plurality of apertures 125 and may be contiguous voids of material in the body member 122 defining a channel within which a structure of the vertical sliding member 140 may slide along.

The body member 122 may further comprise a lower cutout section 126 and an upper cutout section 127. The upper cutout section 127 may be configured to serve as a handle, to at least one of facilitate the rotation of the vertical extension member 120 to a vertical orientation and to carry the device 100 when in a collapsed orientation. The lower cutout section 126 may reduce the weight and material usage of the body member 122 without negatively affecting the strength and integrity of the body member 122.

The body member 122 may further comprise a clip member 128. The clip member 128 may be configured to secure the device 100 in a collapsed orientation. The clip member 128 may accomplish such securing by detachably attaching the body member 122 to the lower interfacing member 112 as shown in FIG. 7.

The vertical sliding member 140 may comprise a distal attaching member 141 and a proximal attaching member 142. The distal attaching member 141 may be positioned on a distal side of the body member 122 and may comprise a plurality of legs (now shown) that extend from a rear surface of the distal attaching member 141 and may be configured to extend through the track channels 124. The proximal attaching member 142 may comprise a plurality of leg apertures 143 configured to permit the plurality of legs to be positioned therewithin to couple the proximal attaching member 142 to the distal attaching member 141. Such coupling may permit a gap to be maintained between the distal and proximal attaching members 141, 142 that the body member 122 may be positioned within. The gap may facilitate the vertical sliding member 140 sliding along the length of the body member 122 as described above. The plurality of legs may be secured within the plurality of leg apertures 143 by any means or method as is known in the art, including, but not limited to, adhesives, welding, interference fits, fasteners, and the like. The extension of the plurality of legs through the track channels 124 may prevent the vertical sliding member 140 from being moved away from the body member 122 and constrain its movement along the length of the track channels 124.

The vertical sliding member 140 may further comprise a position retaining member 144. The position retaining member 144 may be configured to have a portion thereof slide into an aperture of the plurality of apertures 125. When so positioned within an aperture of the plurality of apertures 125, the vertical sliding member 140 may be prevented from vertically translating along the length of the track channels 124. The position retaining member 144 may further comprise a handle configured to facilitate engagement by the user to pull the position retaining member proximally, thereby disengaging it from an aperture of the plurality of apertures 125 and permitting the vertical sliding member 140 to translate vertically along the length of the track channels 124. Additionally, the position retaining member 144 may be biased such that, in its biased position, it is positioned within and engaged with an aperture of the plurality of apertures 125. In such embodiments, the position retaining member 144 may comprise a biasing member, such as a spring.

The vertical sliding member 140 may further comprise a mounting platform 145. The mounting platform 145 may be configured to facilitate the attachment of the arm rotation member 150 thereto. The mounting platform 145 may extend distally from a distal surface of the distal attaching member 141. The mounting platform 145 may comprise a mounting aperture 146. The mounting aperture 146 may be configured to facilitate the positioning of the arm rotation member 150. The mounting aperture 146 may be located towards a distal end of the mounting platform 145 and extend from an upper surface to a lower surface of the mounting platform 145. Additionally, the mounting aperture 146 may be centered along a centerline c of the mounting platform 145. In some embodiments, the mounting aperture 146 may be countersunk or otherwise be chamfered at the upper surface.

The mounting platform 145 may further comprise a plurality of recesses 147 formed in the upper surface. The plurality of recesses 147 may be positioned along an arc having its center be coaxial with the center of the mounting aperture 146. The plurality of recesses 147 may be configured to cooperate with a structure of the arm rotation member 150 to position and retain the arm rotation member 150 at a desired angular position. Each recess of the plurality of recesses 147 may be located along the arc at a particular angular location along the arc. In some embodiments, the plurality of recesses 147 may be positioned at regular or semi-regular angular intervals along the arc, for instance at 15-degree intervals. Any other interval, with gaps therein, are contemplated and included within the scope of the invention. The mounting platform 145 may further comprise a plurality of markings 148 positioned adjacent to the plurality of recesses. The plurality of markings 148 may convey to an observer the angle along the arc at which each recess of the plurality of recesses 147 is located.

The arm rotation member 150 may be configured to attach to the platform member 140 such that the arm rotation member 150 may rotate about axis a. Any means or method of enabling such rotation is contemplated and included within the scope of the invention. In the present embodiment, the arm rotation member may comprise an angle selection structure 151, an angle selection structure retaining member 152, and a rotational attachment member 156. The angle selection structure 151 may have a distal portion 153 defining a distal end of the angle selection structure 151 and a proximal portion 154 extending proximally from the distal portion 153. The proximal portion 154 may comprise a first aperture 160 within which the angle selection structure retaining member 152 may extend through. The proximal portion 154 may further comprise a second aperture 161 positioned distal of the first aperture 160. The second aperture 161 may function as a window, permitting the user to view a marking of the plurality of markings 148 to indicate the user the angular position of the angle selection structure 151. The angle selection structure retaining member 152 may extend through the aperture of the proximal portion 154 and be positioned at least partially within a recess of the plurality of recesses 147, thereby preventing the rotation of the arm rotation member 150 about axis a. The angle selection structure retaining member 152 may comprise a handle 155 that may be manipulable by a user to withdraw the angle selection structure retaining member 152 from the recess of the plurality of recesses 147, thereby enabling the rotation of the arm rotation member 150 about axis a. Once the arm rotation member 150 is rotated to a desired angular position with reference to axis a such that the angle selection structure retaining member 152 aligns with a recess of the plurality of recesses 147, the user may release the handle 155, thereby permitting the angle selection structure retaining member 152 to be positioned within the aligned recess, thereby preventing rotation away from the desired angular position of the arm rotation member 150. In some embodiments, the angle selection structure retaining member 152 may comprise a biasing member, such as a spring, to bias the angle selection structure retaining member 152 in a downward direction to maintain the positioning of the angle selection structure retaining member 152 within a recess of the plurality of recesses 147.

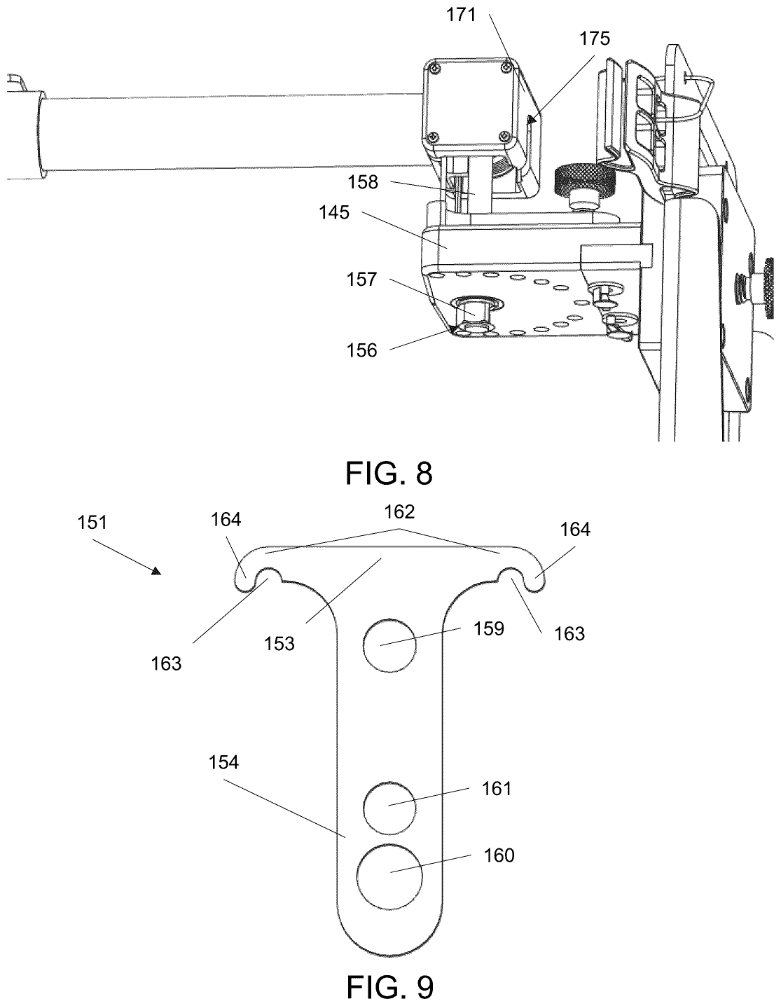

As seen in FIG. 8, The distal portion 153 may also comprise an aperture 159. The arm rotation member 150 may further comprise a platform attaching member 156 configured to rotatably attach the arm rotation member 150 to the platform member 140. Such attachment may simultaneously permit the rotation of the arm rotation member 150 about axis a without any manipulation or interaction with the platform attaching member 156. In the present embodiment, the platform attaching member 156 comprises a nut 157 and a bolt 158, with the nut 157 being positioned below the mounting platform 145 and attaching to the bolt below the mounting platform 145, and the bolt 158 extending from below the mounting platform 145, through the mounting aperture 146, through the aperture 159, and above the mounting platform 145 into a resistance apparatus 170 comprised by the arm rotation member 150, as shown in FIG. 8.

The distal portion 153 may further comprise arms 162. The arms 162 may extend laterally from the distal end of the angle selection structure 151. Each arm 162 may comprise a recess 163 and a hook section 164. The recess 163 and hook section 164 may cooperate to retain a portion of a resistance member comprised by the resistance apparatus 170 as described hereinbelow.

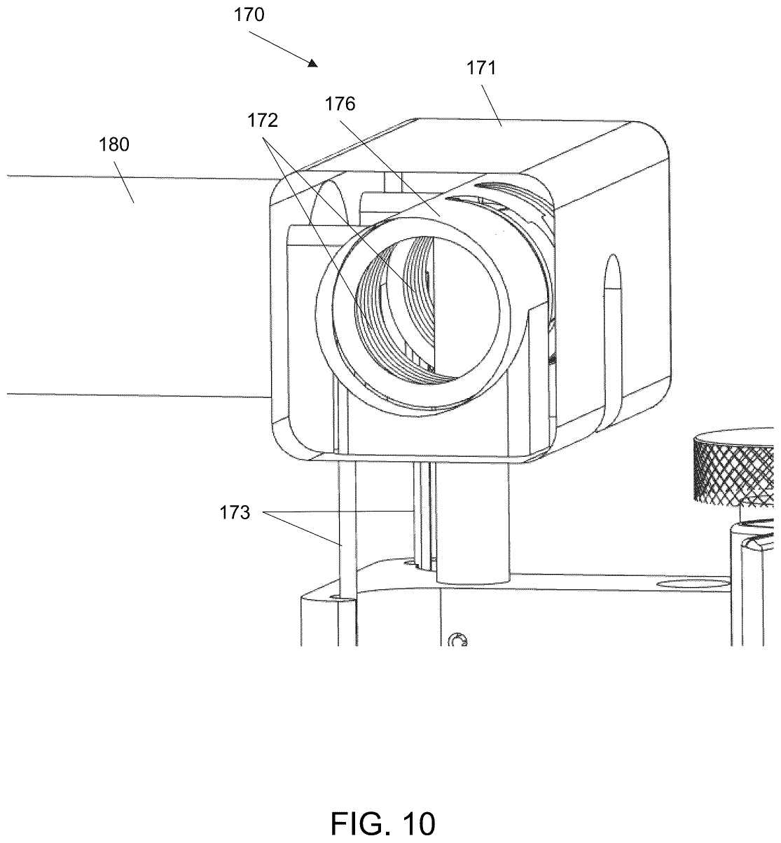

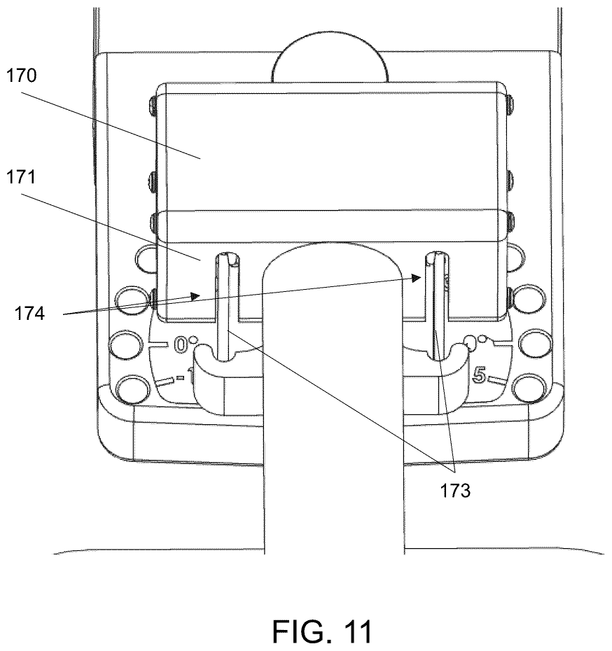

Referring specifically to FIGS. 10 and 11, the resistance apparatus 170 will be discussed in greater detail. The resistance apparatus 170 may comprise a housing 171, a side panel of which is removed in FIG. 10. The arm member 180 may be fixedly attached to a distal panel of the housing 171. Such fixed attachment may result in the resistance apparatus 170 being rotated by the arm member 180 as the arm member 180 is rotated about axis r, and the arm member 180 being rotated by the resistance apparatus 170 as the resistance apparatus 170 is rotated about axis a. The resistance apparatus 170 may further comprise one or more resistance members 172. The resistance members 172 may be configured to resist rotation of the arm member 180 about axis r. In the present embodiment, the resistance members 172 are springs positioned on either tide of bolt 158 within a cavity defined by housing 171. It is contemplated and included within the scope of the invention that other types of devices and structures that may provide resistance may be used, including, but not limited to motors, such as electric motors, including brushless electric motors.

Each spring 172 may have a first end 173 extending downward out of the housing 171 and interfacing with a recess 163. The arms 162 may resist the rotation of the first ends 173 in a distal direction. The housing 171 may comprise distal cutouts 174 formed in a distal panel thereof to permit the first ends 173 to be positioned therein as the rotational apparatus 170 rotates about axis r. The springs 172 may be attached to and carried by an interior structure of the housing 171 such that rotation of the housing about axis r may concordantly cause the rotation of the springs 172, which is resisted by the interface between first ends 173 and arms 162. In the present embodiment, the housing 171 may comprise a spring housing 176 configured to be positioned around and interface with the springs 172, including a second end of the springs 172, and transmit the resistance exerted on the springs 172 via the first ends 173 to the housing 171. The transmission of the resistance to the housing 171 may further be transmitted to the arm member 180 via its connection to the housing 171. Accordingly, the resistance members 172 may resist rotation of the arm member 180 about axis r.

Additionally, as seen in FIG. 8, the housing 171 may further comprise a proximal cutout 175 formed in a proximal panel of the housing 171. The proximal cutout 175 may be configured to permit the bolt 158 to pass therethrough as the resistance apparatus 170 rotated about axis r.

Referring now back to FIGS. 1 and 3, the arm member 180 may comprise an outer tube member 181, a tube coupling member 182, and an inner tube member 183. The arm member 180 may be generally telescopic, with the inner tube member 183 being operable to slide relative to the outer tube member 181 to increase or decrease the length of the arm member 180. The outer tube member 181 may be connected at a proximal end thereof to the distal panel of the housing 171 and extend distally therefrom. The tube coupling member 182 may be attached to a distal end of the outer tube member 181 and be configured to permit the inner tube member 183 to pass therethrough and be releasably secured thereby. The outer tube member 181 may be hollow and have an inner diameter that is greater than an outer diameter of the inner tube member 183, such that the inner tube member 183 may slide into the outer tube member 181 along axis I, thereby changing the length of the arm member 180. When at a desired location, the user may operate the tube coupling member 182 to secure the position of the inner tube member 183, thereby preventing it from translating along axis I. The interfacing member 190 may be positioned towards a distal end of the inner tube member 183. Accordingly, moving the inner tube member 183 along axis Imay change the location of the interfacing member 190, particularly relative to base 110 and/or support member 116. This may be done to position the interfacing member 190 to conform to the physiology of the patient, who will be laying on support member 116. To reposition the interfacing member 190, a user may operate the tube coupling member 182 to unsecure, release, or otherwise enable the inner tube member 183 to slide along axis Ito change the length of arm member 180 and the position of interfacing member 190. Once interfacing member 190 is positioned at a desired location, the user may once again operate the tube coupling member 182 to secure the inner tube member 183 at its current location. The tube coupling member 182 may be any device or structure operable to accomplish the securing described hereinabove, including, but not limited to, clamping devices, specifically, a device having a first end configured to form an interference fit with the outer surface of a larger tube member and a second end configured to clamp onto a smaller tube member.

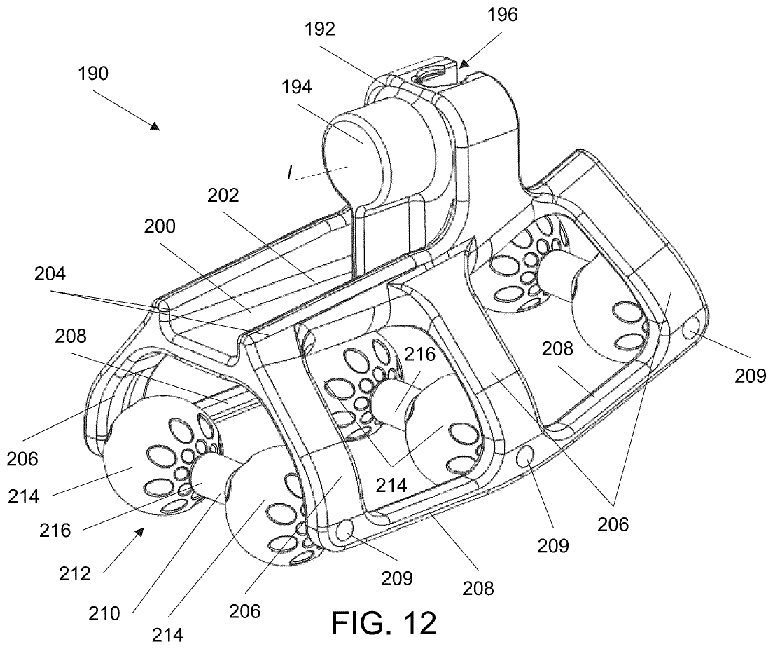

Referring now to FIGS. 1 and 12, the interfacing member 190 will now be discussed in greater detail. As mentioned above, the interfacing member 190 may be coupled to the inner tube member 183 towards a distal end thereof. The interfacing member 190 may be configured to interface with the body of the patient to facilitate sacroiliac joint exercises, such as side lying leg lifts. The interfacing member 190 may be configured to interface with the hip/leg area of the patient. The interfacing member 190 may comprise an attachment section 192, a body section 200, and an interfacing section 210. The attachment section 192 may be generally configured to attach the interfacing member 190 to the distal end of the arm member 180, in some embodiments the distal end of the inner tube member 183. The interfacing section 210 may be configured to interface with the patient as described. The body section 200 may be configured to connect the interfacing section 210 and the attachment section 192.

The attachment section 192 may comprise an arm receiving section 194 configured to permit the distal end of the arm member 180, in this embodiment the inner tube member 183, therein. The arm receiving section 194 may be configured either fixedly or removably couple with the arm member 180/inner tube member 183 by any means or method as is known in the art, including, but not limited to, interference fits, couplers, magnetic attachment, releasable clamping, and the like. The attachment section 192 may further comprise a coupler cutout 196 configured to permit the tube coupling member 182 to be positioned at least partially therewithin. This may facilitate shortening the length of the arm member 180 to the greatest extent possible, either to accommodate the physiology of the patient or to facilitate storage of the device 100.

The body section 200 may be connected to, and in some embodiments integrally formed with, at least part of the attachment section 192 and be elongated along axis I. The body section 200 may comprise an upper wall 202, opposing upper sidewalls 204, a plurality of downward-extending arm members 206, and lower connecting members 208. The upper wall 202 may primarily define the distal length of the interfacing member 190, although it does not extend to the proximal end of the interfacing member 190. The opposing upper sidewalls 204 may run longitudinally along the edge of the upper wall 202, improving the strength and resistance to flexure of the body section 200. The plurality of downward-extending arm members 206 may be attached to or integrally formed with one or both of the upper wall 202 and the upper sidewalls 204 at an upper end thereof and extend downward and laterally outward therefrom. The lower connecting members 208 may be attached to or integrally formed with the plurality of downward-extending arm members 206 at a lower end of the plurality of downward-extending arm members 206, serving to connect plurality of downward-extending arm members 206 located on the same side of axis I. The interfacing member 190 may further comprise a plurality of apertures 209 configured to facilitate attachment of the interfacing section 210. The plurality of apertures 209 may be formed in the lower connecting members 208, the plurality of downward-extending arm members 206, or at a connection/transition point or area therebetween.

The interfacing section 210 may comprise one or more interfacing devices 212 configured to facilitate interfacing between the patient and the interfacing member 190. The interfacing section 210 may be configured to interface with the patient and be moved by the patient as the patient raises and lowers their leg/hip. Such movement may rotate the interfacing member 190 about axis r, and may concordantly rotate the arm member 180 and the resistance apparatus 170 about axis r, causing the resistive force as described above to be exerted, transmitted up arm member 180 and to interfacing member 190, causing the patient to have to overcome the resistive force to continue to rotate the interfacing member 190 about axis r or permit it to be rotated by the resistive force back to a neutral angular position, i.e. when resistance members 172 stop extending a resistive force. The interfacing devices 212 of the present embodiment each comprise rotating members 214 positioned adjacent an inner surface of the plurality of downward-extending arm members 206 and a connecting member 216 positioned between the rotating member 214. In some embodiments, the connecting member 216 is fixedly attached to the rotating members 214, causing the connected rotating members 214 to rotate together. In other embodiments, the connection between the connecting member 216 and the rotating members 214 may be such that the rotating members 214 can each rotate independently of the connecting member 216 and/or the other rotating member 214. The rotating members 214 may be generally spherical/rounded to facilitate rolling over the interface with the patient, assisting in keeping the patient interfaced therewith as the patient raises and lowers their leg. The rotating members 214 may have an outer dimension that is greater than the outer dimension of the connecting member 216, such that it is the rotating members 214 that interface with the patient and not the connecting member 216. The interfacing devices 212 may further comprise attachment means/members configured to attach the interfacing devices to the downward-extending arm members 206 and/or the lower connecting members 208. For example, fasteners may be positioned through the apertures 209 and connected to one of the rotating members 214. Such attachment may enable the rotation of the rotating members 214 as described. Such attachment is exemplary only, and any means or method of attachment as is known in the art is contemplated and included within the scope of the invention.

While particular interfacing devices 212 are shown in FIG. 12, it is contemplated and included within the scope of the invention that any structure or device that may facilitate interfacing with a patient as described herein and maintaining such interfacing as the patient raises and lowers their leg is contemplated and included within the scope of the invention.

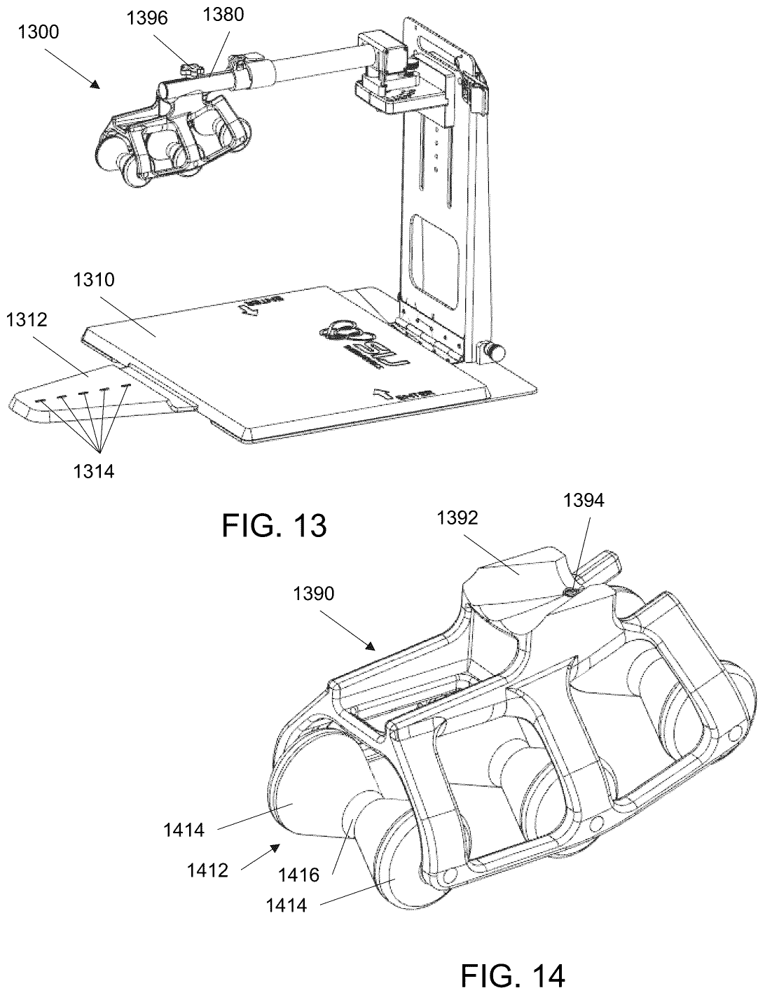

Referring now to FIGS. 13-14, an SIJ exercise device 1300 according to another embodiment of the invention is presented. Similar to the embodiment shown in FIGS. 1-12, the SIJ exercise device 1300 may comprise a base 1310. The base 1310 of the present embodiment comprises a distal member 1312 extending distally from a main section of the base 1310. The distal member 1312 comprises a plurality of slots 1314 formed in an upper surface thereof. The plurality of slots 1314 may be configured to permit a vertical wall member to be positioned therein to facilitate the positioning of the user of the SIJ exercise device 1300. In the present embodiment, the plurality of slots 1314 are aligned and evenly spaced. Any number and distribution of slots of the plurality of slots 1314 is contemplated and included within the scope of the invention.

The SIJ exercise device 1300 further comprises an interfacing apparatus 1390. The interfacing apparatus 1390 may differ from the interfacing apparatus 190 of the SIJ exercise device 100 of FIGS. 1-12 in a number of ways. First, the attachment section 1392 may be configured not to circumscribe the arm member 1380, but instead to be removably attached by a threaded aperture 1394 configured to engage with a screw member 1396 that may also engage with a threaded aperture of the arm member 1380.

Additionally, the interfacing devices 1412 may have a different configuration/geometry. Specifically, the rotating members 1414 may have a generally conical shape, but are similarly configured to rotate independently of each other and the connecting member 1416. The rotating members 1414 may taper in the direction of the connecting member Any other geometry/shape of the rotating members 1414 is contemplated and included within the scope of the invention.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. An exercise device comprising:
a base;
a vertical extension member configured to extend upward from the base;
a vertical sliding member configured to slide along a portion of a length of the vertical extension member;
an arm rotation member configured to attach to the vertical sliding member, rotate about a first axis, and be selectively retained in an angular location about the first axis;
an arm member;
a resistance apparatus configured to:
attach to the arm rotation member and to the arm member at a first end of the arm member; and
provide resisted rotation of the arm member about a second axis; and
an interfacing member attached toward a second end of the arm member and configured to interface with the body of a user and enable the user to rotate the arm member about the second axis.

2. The exercise device of claim 1 wherein the arm member is a telescoping arm member operable to extend along a longitudinal axis thereof, the arm member further comprising a tube coupling member operable to secure the arm member at a desired length.

3. The exercise device of claim 1 wherein:
the vertical sliding member comprises a mounting platform, the mounting platform comprising a plurality of recesses; and
the arm rotation member is attached to the mounting platform and comprises an angle selection structure configured to be positionable within the recesses of the plurality of recesses to selectively retain the arm rotation member in an angular rotation about the first axis.

4. The exercise device of claim 3 wherein the recesses of the plurality of recesses are positioned at angular intervals and along an arc.

5. The exercise device of claim 3 wherein the angle selection structure comprises:
an aperture configured to align with the recesses of the plurality of recesses; and
an angle selection structure retaining member configured to pass through the aperture and into the recesses of the plurality of recesses.

6. The exercise device of claim 1 wherein:
the vertical extension member comprises:
one or more track channels extending vertically along the vertical extension member; and
a plurality of apertures; and
the vertical sliding member comprises:
one or more attaching members configured to slidably attach the vertical sliding member to the vertical extension members such that the vertical sliding member may translate along the one or more track channels; and
a position retaining member configured to be selectively positionable within the plurality of apertures to selectively retain the vertical sliding member at a vertical position along the vertical extension member.

7. The exercise device of claim 1 wherein the resistance apparatus comprises:
a housing; and
at least one resistance member positioned at least partially within the housing and configured to resist rotation about the second axis in at least one direction.

8. The exercise device of claim 7 wherein:
rotation of the arm member about the second axis causes the housing to rotate about the second axis;
the at least one resistance member comprises at least one spring;
a first end of the at least one spring is positioned to interface with a structure of the arm rotation member;
a second end of the at least one spring is positioned to interface with the housing and be rotated as the housing rotates about the second axis; and
rotation of the second end of the at least one spring is prevented by the interface with a structure of the arm rotation member, causing resistance to the rotation of the first end of the at least one spring, and thereby resisting rotation of the arm member about the second axis.

9. The exercise device of claim 8 wherein:
the at least one resistance member comprises two springs;
the first end of the two springs extends downward from the housing and interfaces with a recess comprised by an arm of an angle selection structure of the arm rotation member; and
the second end of the two springs interfaces with a spring housing comprised by the housing.

10. The exercise device of claim 1 wherein the interfacing member comprises:
an attachment section configured to attach to the arm member;
a body section; and
one or more interfacing devices carried by the body section and configured to interface with the body of the user.

11. The exercise device of claim 10 wherein the one or more interfacing devices comprises at least one rotating member configured to rotate while interfaced with the body of the user.

12. The exercise device of claim 1 wherein the vertical extension member further comprises an attachment structure configured to rotatably attach the vertical extension member to the base such that the vertical extension member is rotatable about a third axis relative to the base.

13. The exercise device of claim 1 wherein the first axis is perpendicular to the second axis.

14. An exercise device comprising:
a base;
a vertical extension member configured to extend upward from the base;
a vertical sliding member configured to slide along a portion of a length of the vertical extension member and comprising a mounting platform, the mounting platform comprising a plurality of recesses positioned at regular angular intervals and along an arc;
an arm rotation member attached to the mounting platform and configured to rotate about a first axis, the arm rotation member comprising an angle selection structure configured to be positionable within the recesses of the plurality of recesses to selectively retain the arm rotation member in an angular rotation about the first axis;
a telescopic arm member;
a resistance apparatus configured to:
attach to the arm rotation member and to the arm member at a first end of the arm member; and
provide resisted rotation of the arm member about a second axis; and
an interfacing member attached toward a second end of the arm member and configured to interface with the body of a user and enable the user to rotate the arm member about the second axis.

15. The exercise device of claim 14 wherein the angle selection structure comprises:
an aperture configured to align with the recesses of the plurality of recesses; and
an angle selection structure retaining member configured to pass through the aperture and into the recesses of the plurality of recesses.

16. The exercise device of claim 14 wherein:
the vertical extension member comprises:
one or more track channels extending vertically along the vertical extension member; and
a plurality of apertures; and
the vertical sliding member comprises:
one or more attaching members configured to slidably attach the vertical sliding member to the vertical extension members such that the vertical sliding member may translate along the one or more track channels; and
a position retaining member configured to be selectively positionable within the plurality of apertures to selectively retain the vertical sliding member at a vertical position along the vertical extension member.

17. The exercise device of claim 14 wherein the resistance apparatus comprises:
a housing; and
at least one resistance member positioned at least partially within the housing and configured to resist rotation about the second axis in at least one direction.

18. The exercise device of claim 17 wherein:
rotation of the arm member about the second axis causes the housing to rotate about the second axis;
the at least one resistance member comprises two springs;
a first end of the springs extends downward from the housing and interfaces with a recess comprised by an arm of the angle selection structure;
a second end of the springs is positioned to interface with the housing and be rotated as the housing rotates about the second axis; and
rotation of the second end of the at least one spring is prevented by the interface with a structure of the arm rotation member, causing resistance to the rotation of the first end of the at least one spring, and thereby resisting rotation of the arm member about the second axis.

19. The exercise device of claim 14 wherein the interfacing member comprises:
an attachment section configured to attach to the arm member;
a body section; and
one or more interfacing devices carried by the body section and configured to interface with the body of the user.

20. The exercise device of claim 19 wherein the one or more interfacing devices comprises at least one rotating member configured to rotate while interfaced with the body of the user.
